(19) United States
(12) Patent Application Publication
(10) Pub. No.: US 2015/0288792 A1
(43) Pub. Date: Oct. 8, 2015

(54) BI-LEVEL BI-CLASS THERMAL MITIGATION TECHNIQUE FOR SINGLE/MULTI-SIM DEVICES

(71) Applicant: QUALCOMM INCORPORATED, San Diego, CA (US)

(72) Inventors: Shivank Nayak, San Diego, CA (US); Shilpa Nagpal, Rajpura (IN); Ajeet Kumar, Sitamarhi (IN)

(73) Assignee: QUALCOMM INCORPORATED, San Diego, CA (US)

(21) Appl. No.: 14/246,185

(22) Filed: Apr. 7, 2014

(51) Int. Cl. H04M 1/675; H04M 1/21; H04M 1/02

(52) U.S. Cl. CPC H04M 1/675; H04M 1/026; H04M 1/21

(57) ABSTRACT

A method of providing thermal mitigation for a mobile device includes: receiving at least one temperature signal indicative of at least one operating temperature of the mobile device; comparing the at least one temperature signal to a plurality of progressively higher temperature thresholds; and selecting one of a plurality of thermal mitigation plans based on one of a plurality of mobile device operating modes and the comparison of the at least one temperature signal with the plurality of temperature thresholds

### BACKGROUND

Thermal mitigation for a mobile device is a primary requirement which not only ensures user safety but also increases device reliability. Defining a proper thermal threshold and reducing the functionality of device to maintain temperatures below the threshold can ensure that device components are not damaged. After cool down, the device can regain full functionality.

Generally, the thermal threshold of a mobile device is selected based on a safe operating temperature to prevent damage to the electronic circuit components of the mobile device. However, a thermal threshold set for a safe operating temperature for electronic circuit components to guarantees device safety may still be too high to guarantee human safety.

### SUMMARY

Apparatuses and methods for bi-level bi-class thermal mitigation technique for single and multi-SIM devices are provided.

According to various embodiments of the disclosure there is provided a mobile device. The mobile device may include: one or more communication units configured to communicate with one or more communication networks; a control unit configured to control operation of the mobile device; a storage configured to store operating instructions for the control unit; and one or more temperature sensors configured to sense operating temperatures of the mobile device and provide temperature signals to the control unit.

The control unit may be configured to compare the temperature signals to a plurality of progressively higher temperature thresholds, and to select one of a plurality of thermal mitigation plans based on one of a plurality of mobile device operating modes and the comparison of the temperature signals with the plurality of temperature thresholds.

According to various embodiments of the disclosure there is provided method of providing thermal mitigation for a mobile device. The method may include: receiving at least one temperature signal indicative of operating temperatures of the mobile device; comparing the at least one temperature signal to a plurality of progressively higher temperature thresholds; and selecting one of a plurality of thermal mitigation plans based on one of a plurality of mobile device operating modes and the comparison of the at least one temperature signal with the plurality of temperature thresholds.

Other features and advantages of the present inventive concept should be apparent from the following description which illustrates by way of example aspects of the present inventive concept.

### BRIEF DESCRIPTION OF THE DRAWINGS

Aspects and features of the present inventive concept will be more apparent by describing example embodiments with reference to the accompanying drawings, in which:

FIG. 1 is a block diagram illustrating a mobile device according to various embodiments of the disclosure;

FIG. 2 is a diagram illustrating the concept of classes of services to be suspended according to various embodiments of the disclosure; and

FIG. 3 is a flowchart illustrating a method of performing thermal mitigation for a mobile device according to various embodiments of the disclosure.

### DETAILED DESCRIPTION

While certain embodiments are described, these embodiments are presented by way of example only, and are not intended to limit the scope of protection. The apparatuses, methods, and systems described herein may be embodied in a variety of other forms. Furthermore, various omissions, substitutions, and changes in the form of the example methods and systems described herein may be made without departing from the scope of protection.

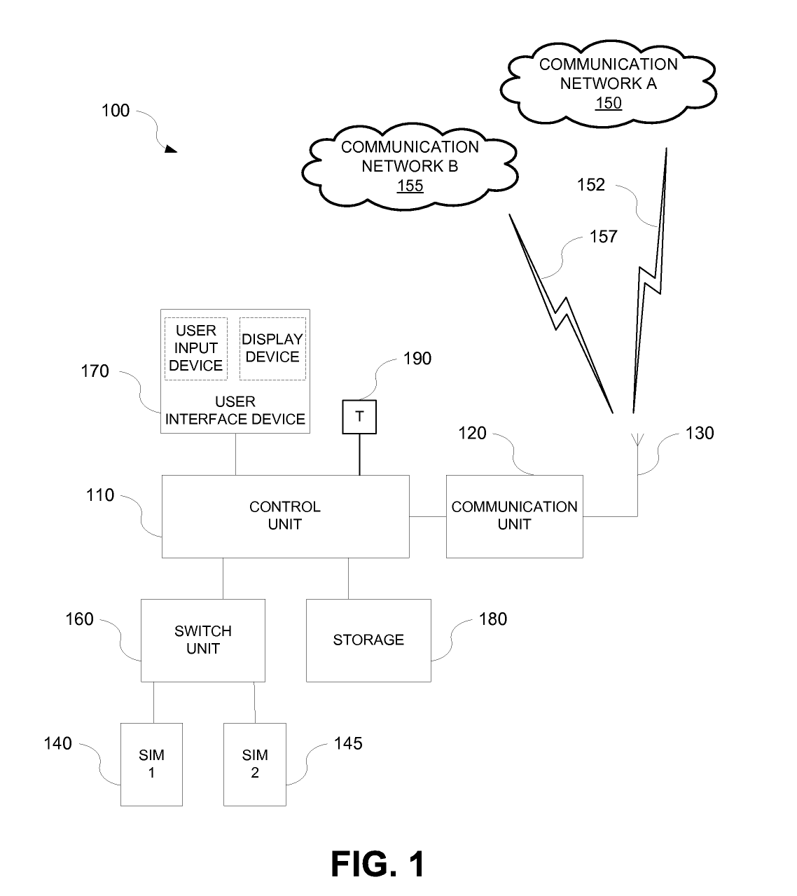

FIG. 1 is a block diagram illustrating a dual-SIM, dual-active (DSDA) mobile device 100 according to various embodiments of the disclosure. The mobile device 100 may include a control unit 110, a communications unit 120, an antenna 130, a first subscriber identity module (SIM) 140 that associates the mobile device 100 with a first subscription (Sub 1) 152, a second SIM 145 that associates the mobile device 100 with a second subscription (Sub 2) 157, a switch unit 160, an interface device 170, storage 180, and one or more temperature sensors 190.

In some embodiments, the communication unit 120 may include one transceiver operable to communicate on Sub 1 152 and Sub2 157 via the first and second SIMs 140, 145, respectively. In other embodiments, the communication unit 120 may include two transceivers, one operable to communicate on Sub 1 152 via the first SIM 140 and another operable to communicate on Sub2 157 via the second SIM 145. Sub 1 152 and Sub2 157 may be subscriptions on the same or different networks. One of ordinary skill in the art will appreciate that various example embodiments the communication unit 120 may include more than two SIMS communicating on respective subscriptions via one or more transceivers without departing from the scope of the present inventive concept.

The mobile device 100 may be, for example but not limited to, a mobile telephone, smartphone, tablet, computer, etc., capable of mobile communications with one or more wireless networks.

The communication unit 120 transmits and receives radio frequency (RF) signals to and from wireless communication networks 150, 155 through the antenna 130. The first SIM 140 and the second SIM 145 contain subscriber identification information for the network service subscriptions 152, 157 and are electrically connected to the control unit 110 through the switch unit 160. The switch unit 160 is configured to electrically connect the first SIM 140, the second SIM 145, or both the first SIM 140 and the second SIM 145 to the control unit 110. The one or more temperature sensors 190 are positioned within an enclosure of the mobile device 100 to sense temperature of the enclosure and/or operating temperature of the electronic circuitry of the mobile device 100. The one or more temperature sensors 190 provide temperature signals corresponding to the sensed temperatures to the control unit 110. While only one temperature sensor 190 is illustrated, one of ordinary skill in the art will appreciate that more than one temperature sensor may be used.

The control unit 110 controls overall operation of the mobile device 100 including control of the communications unit 120, switch unit 160, interface device 170, and storage 180, as well as execution of applications and other mobile device functions. The control unit 110 may be a programmable device, for example, but not limited to, a microprocessor or microcontroller. The storage 180 may store application programs necessary for operation of the mobile device 100 that are executed by the control unit 110, as well as application data and user data.

When the mobile device 100 is in operation, the more functions that are being performed and/or features that are activated, the more power consumption of the mobile device 100 is increased. Increased power consumption results in higher device operating temperatures. The one or more temperature sensors 190 sense the temperature of the mobile device 100 and provide one or more temperature signals to the control unit 110. The control unit 110 compares the one or more temperature signals to one or more temperature threshold values and may perform thermal mitigation operations based on the results of the comparison.

Multiple temperature threshold values may be set based on, for example, a safe operating temperature for human safety and a safe operating temperature that will prevent damage to the mobile device. Different thermal mitigation plans may be implemented based on operational states and operating temperatures of the mobile device. For example, different thermal mitigation plans may be implemented at different thermal thresholds (e.g., tlevel1 and tlevel2) for various usage patterns of services on the mobile device 100 (e.g., operational mode 1 and operational mode 2), that suspend different classes of services (e.g., sclass1 and sclass2) allowing the mobile device 100 to cool down. One of ordinary skill in the art will appreciate that mobile device services include, but are not limited to, applications, operational features, functional services, etc.

In some embodiments, temperature threshold tlevel1 (also referred to as a first temperature threshold) may be set to a temperature consistent with human safety, i.e., a temperature that a normal human being can sustain without causing harm to the human being, for example, about 40 degrees Celsius (or other predetermined temperature threshold). Temperature threshold tlevel2 (also referred to as a second temperature threshold) may be set to a temperature consistent with a safe operating temperature to prevent damage to the mobile device 100, i.e., a temperature that the mobile device 100 can sustain for a period of time without damage to the mobile device 100, for example, about 65 degrees Celsius (or other predetermined temperature threshold).

When the mobile device operating temperature reaches a first (lower) temperature threshold (tlevel1) in a first operational mode, a first predefined class of services 210, sclass1, for example, but not limited to, activities on inactive subscriptions in the case of a multi-SIM device, active PS calls, etc., will be suspended to allow the mobile device 100 to cool down. In addition to suspending the sclass1 services, the discontinuous reception (DRX) cycle may be increased.

In a second operational mode, when the mobile device operating temperature reaches a second (higher) temperature threshold (tlevel2) a second predefined class of services 220, sclass2, for example, but not limited to, all active calls and all subscriptions in the case of a multi-SIM device, will be suspended to allow the mobile device 100 to cool down. In addition to suspending the sclass1 services, the mobile device may be put in a low power mode (LPM).

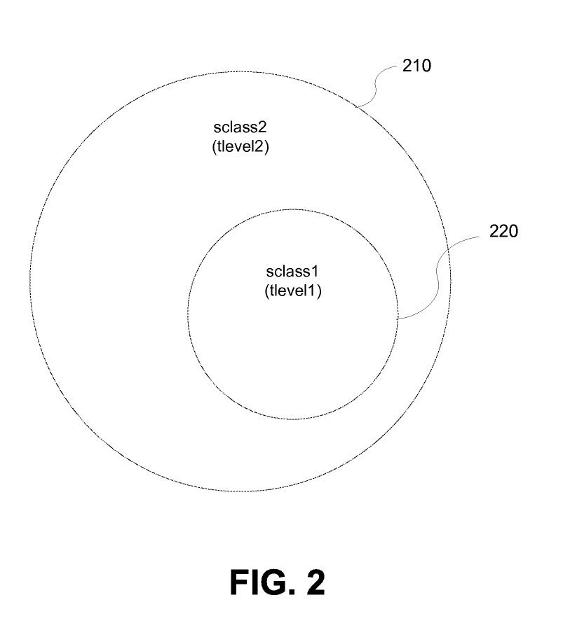

FIG. 2 is a diagram illustrating the concept of classes of services to be suspended based on the thermal thresholds and operational modes of the mobile device 100 (refer to FIG. 1) according to various embodiments of the disclosure. With reference to FIGS. 1 and 2, the first predefined class of services 210, sclass1, is a subset of the second predefined class of services 220, sclass2. Thus, if the temperature threshold tlevel2 is reached, all services in both sclass1 and sclass2 will be suspended.

In some embodiments, the mobile device 100 may be in a first operational mode (operational mode 1) when the mobile device 100 is performing operations in close proximity to a user's face, for example, but not limited to, a voice call, and no accessory enabling the mobile device to be operated at a distance from a user's face, for example, a wired or wireless headphone, is connected to the mobile device 100. The mobile device 100 may be in close proximity to a user's face when it is within about on inch of the user's face (e.g., as determined by the mobile device 100). Thus, while in a voice call the mobile device 100 may determine that the mobile device 100 is in contact or otherwise in proximity with the user's face. When the device operating temperature reaches tlevel1, a first thermal mitigation plan may be implemented by suspending the services that belong to sclass1 to allow the mobile device 100 to cool.

In some embodiments, the mobile device 100 may be in a second operational mode (operational mode 2) when the mobile device 100 is in voice call and a wired/wireless accessory, for example, but not limited to headphones, is in use enabling the mobile device 100 to be operated at a distance from a user's face. The mobile device 100 may also be in the second operational mode when the mobile device 100 is performing other operations enabling the mobile device 100 to be operated at a distance from a user's face, for example, but not limited to, implementing speakerphone, enabling a hands-free mode, performing a packet switched (PS) call, or executing certain applications (e.g., a game or the like). In these cases, the mobile device 100 will not be in contact or otherwise in proximity with the user's face.

Thermal mitigation plans may be determined based on temperature thresholds and the operational modes of the mobile device 100. One of ordinary skill in the art will appreciate that multiple thermal thresholds, multiple mobile device operational modes, multiple classes of services, and multiple mitigation plans can be defined.

In some embodiments, with the mobile device 100 in contact (or otherwise in proximity) with a user's face in a first operational mode, when the mobile device operating temperature reaches a first (lowest) temperature threshold (tlevel1) (e.g., at a temperature consistent with human safety), a first thermal mitigation plan may be implemented to suspend mobile device services in the first service class (sclass 1). However, if the mobile device 100 is operating in operational mode 2, i.e., the mobile device 100 is not in contact (or otherwise in proximity) with the user's face, the first thermal mitigation plan may not be implemented, and the mobile device 100 may remain fully functional.

In operational mode 2, if the operating temperature of the mobile device 100 reaches the second temperature threshold (tlevel2) higher than tlevel1(e.g., at a temperature consistent with a safe operating temperature to prevent damage to the mobile device 100), the thermal mitigation plan 2 may be implemented to suspend mobile device services in the second service class (sclass2).

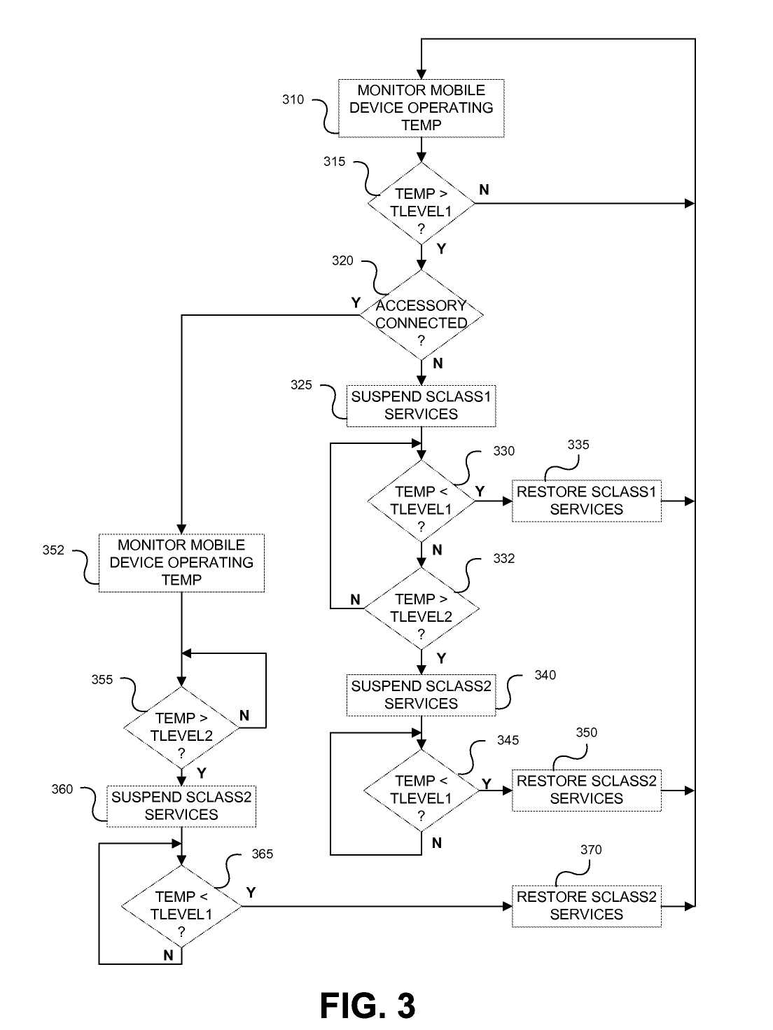

FIG. 3 is a flowchart illustrating a method of performing thermal mitigation for a mobile device according to various embodiments of the disclosure. With reference to FIGS. 1 and 3, mobile device 100 temperature increases as a result of the active functions and applications executing on the mobile device 100. The control unit 110 monitors mobile device operating temperature via temperature signals received from the one or more temperature sensors 190 indicating the operating temperature of the mobile device 100 (310). The control unit 110 compares a mobile device operating temperature value determined from the received temperature signal to a value of the first (lowest) temperature threshold, tlevel1 (315).

If the control unit 110 determines that the mobile device operating temperature is greater than the first (lowest) temperature threshold, tlevel1 (315-Y), the control unit 110 determines whether the mobile device 100 is in a first operational mode or a second operational mode based on whether an accessory, for example, a wired or wireless headphone, is connected to mobile device 100 (320).

If no accessory enabling the mobile device 100 to be operated at a distance from a user's face is connected to the mobile device 100 (320-N), the control unit 110 may determine that the mobile device 100 is in a first operational mode and implements a first thermal mitigation plan by suspending the services in sclass1 (325). When the control unit 110 determines based on the temperature signal received from the one or more temperature sensors 190 that the operating temperature of the mobile device 100 cools to a temperature or predetermined temperature (e.g., 5 degrees Celsius below tlevel1) below the first temperature threshold tlevel1 (330-Y), the sclass1 services are restored (335).

However, if the control unit 110 determines that the operating temperature of the mobile device 100 continues to increase (330-N) to a temperature higher than the second (higher) temperature threshold tlevel2 (332-Y) after implementing the first thermal mitigation plan, then the control unit 110 implements a second thermal mitigation plan by suspending the services in sclass2 (340).

When the control unit 110 determines based on the temperature signal received from the one or more temperature sensors 190 that the operating temperature of the mobile device 100 cools to a predetermined temperature below the first (lower) temperature threshold tlevel1 after implementing the second thermal mitigation plan (345-Y), the sclass2 services are restored (350). In some embodiments, sclass2 services may be restored when the mobile device 100 cools to a predetermined temperature below the second (higher) temperature threshold tlevel2.

If the control unit 110 determines at operation 320 that an accessory is connected to the mobile device 100 (or that the mobile device 100 is otherwise not in proximity with the user's face) (320-Y), then the control unit 110 may determine that the mobile device 100 is in the second operational mode, and a thermal mitigation plan is not implemented at this time. The control unit 110 continues to monitor operating temperature via the temperature signal from the thermal sensor 190.

If the control unit 110 determines that the mobile device operating temperature is greater than the second (higher) temperature threshold, tlevel2 (355-Y), the control unit 110 implements the second thermal mitigation plan by suspending the services in sclass2 (360).

When the control unit 110 determines based on the temperature signal received from the temperature sensor 190 that the operating temperature of the enclosure of the mobile device 100 cools to a predetermined temperature below the first (lower) temperature threshold tlevel1 (365-Y), the sclass2 services are restored (370). The predetermined temperature may be, for example, about 5 degrees or 10 degrees below the first (lower) temperature threshold. In some embodiments, sclass2 services may be restored when the mobile device 100 cools to a predetermined temperature below the second (higher) temperature threshold tlevel2.

In some embodiments, several progressive temperature thresholds may be set based on the mobile device 100 operating mode, and a corresponding thermal mitigation plan implemented at each temperature threshold. A DSDA mobile device (e.g., the mobile device 100) may be in a first operational mode (operational mode 1) when the mobile device is performing operations in close proximity to a user's face. For example, a voice call may be ongoing on Sub 2 157 while an active data download of a large file is ongoing on Sub 1 155. Over time, the operating temperature of the mobile device 100 will increase and successively cross the several temperature thresholds set at progressively higher temperatures, and a different thermal mitigation plan may be implemented at each threshold crossing.

In this case, when the operating temperature of the mobile device 100 reaches a first threshold, the voice call (i.e., the primary activity) may be maintained on Sub 2 157 while the speed of the data download on Sub 1 155 may be reduced, for example by half, to lessen processing power and battery consumption which will slow the increase of operating temperature of the mobile device 100. If thermal mitigation is successful, the mobile device temperature may not reach the next temperature threshold. However, if mobile device operating temperature continues to increase, a second thermal mitigation plan may be implemented when the operating temperature reaches a second temperature threshold.

Under the thermal mitigation plan at the second temperature threshold, the voice call may be maintained on Sub 2 157 while all the activity on Sub 1 155 (i.e., the background data download activity) is stopped and the RF section of the mobile device 100 related to Sub 1 155 is shutdown. If mobile device operating temperature still continues to increase and reaches a third temperature threshold, a third thermal mitigation plan may cause a shutdown of the RF section of the mobile device related to Sub 2 157, i.e., the subscription on which the voice call was active, and provide emergency only operation of the mobile device 100.

Thus, the thermal mitigation plans are designed to control mobile device temperature by suspending classes of service while providing the least impact to the user by progressively reducing or stopping the classes of service. Each class of suspended mobile device services is a subset of the class of mobile device services suspended by the thermal mitigation plan corresponding to the next higher temperature threshold.

In a second operational mode (operational mode 2) the DSDA mobile device 100 may be operated at a distance from a user's face in a hands-free mode. For example, a video call may be ongoing on Sub 2 157 while an active data download of a large file is ongoing on Sub 1 155. Over time, the operating temperature of the mobile device 100 will increase and successively cross the several temperature thresholds set at progressively higher temperatures, and a different thermal mitigation plan may be implemented at each threshold crossing.

In this case, when the operating temperature of the mobile device 100 reaches a first threshold, the video call (i.e., the primary activity) may be maintained on Sub 2 157 while the speed of the data download on Sub 1 155 may be reduced, for example by half, to lessen processing power and battery consumption which will slow the increase of operating temperature of the mobile device 100. If thermal mitigation is successful, the mobile device temperature may not reach the next temperature threshold. However, if mobile device operating temperature continues to increase, a second thermal mitigation plan may be implemented when the operating temperature reaches a second temperature threshold.

At the second temperature threshold, the second thermal mitigation plan may maintain the video call on Sub 2 157 while stopping all the activity on Sub 1 155 (i.e., the background data download activity) and shutting down the RF section of the mobile device 100 related to Sub 1 155. If the mobile device operating temperature continues to increase to a third temperature threshold, a third thermal mitigation plan may stop the data service on Sub 2 157. In this case, the video call may be dropped, but voice service may be maintained.

If mobile device operating temperature still continues to increase and reaches a fourth temperature threshold, a fourth thermal mitigation plan may cause a shutdown of the RF section of the mobile device 100 related to Sub 2 157, i.e., the subscription on which the voice call was active, and provide emergency only operation of the mobile device 100.

In various example embodiments, the thermal mitigation plans are designed to control mobile device temperature by suspending classes of service while providing the least impact to the user by progressively reducing or stopping the classes of service. Each class of suspended mobile device services is a subset of the class of mobile device services suspended by the thermal mitigation plan corresponding to the next higher temperature threshold.

The accompanying claims and their equivalents are intended to cover such forms or modifications as would fall within the scope and spirit of the protection. For example, the example apparatuses, methods, and systems disclosed herein can be applied to multi-SIM or single-SIM mobile devices as well as mobile devices having one or multiple radios. Further, various thermal thresholds may be defined and thermal mitigation plans implemented to control mobile device services in relation to their impact on the primary mobile device activity. The various components illustrated in the figures may be implemented as, for example, but not limited to, software and/or firmware on a processor, ASIC/FPGA/DSP, or dedicated hardware. Also, the features and attributes of the specific example embodiments disclosed above may be combined in different ways to form additional embodiments, all of which fall within the scope of the present disclosure.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an,” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof If implemented in software, the functions may be stored as one or more instructions or code on a non-transitory computer-readable storage medium or non-transitory processor-readable storage medium. The steps of a method or algorithm disclosed herein may be embodied in processor-executable instructions that may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

Although the present disclosure provides certain example embodiments and applications, other embodiments that are apparent to those of ordinary skill in the art, including embodiments which do not provide all of the features and advantages set forth herein, are also within the scope of this disclosure. Accordingly, the scope of the present disclosure is intended to be defined only by reference to the appended claims.

What is claimed is:

1. A mobile device, comprising:
one or more communication units configured to communicate with one or more communication networks;
a control unit configured to control operation of the mobile device;
a storage configured to store operating instructions for the control unit; and
one or more temperature sensors configured to sense operating temperatures of the mobile device and provide temperature signals to the control unit,
wherein the control unit is configured to compare the temperature signals to a plurality of progressively higher temperature thresholds, and to select one of a plurality of thermal mitigation plans based on one of a plurality of mobile device operating modes and the comparison of the temperature signals with the plurality of temperature thresholds.

2. The mobile device of claim 1,
wherein the control unit is configured to determine a first operating mode when the mobile device is performing operations usually performed in close proximity to a user's face and no accessories enabling the mobile device to be operated at a distance from a user's face are connected to the mobile device; and
wherein the control unit is configured to determine a second operating mode when an accessory enabling the mobile device to be operated at a distance from a user's face is connected to the mobile device.

3. The mobile device of claim 1,
wherein the control unit is configured to determine a first operating mode when the mobile device is performing operations usually performed in close proximity to a user's face and no accessories enabling the mobile device to be operated at a distance from a user's face are connected to the mobile device; and
wherein the control unit is configured to determine a second operating mode when the mobile device is performing operations enabling the mobile device to be operated at a distance from a user's face.

4. The mobile device of claim 1, wherein a first temperature threshold of the plurality of temperature thresholds is set to a temperature consistent with human safety, and a second temperature threshold of the plurality of temperature thresholds is set to a temperature consistent with a safe operating temperature to prevent damage to the mobile device.

5. The mobile device of claim 1, wherein the one or more temperature sensors are disposed within the mobile device to sense one or more of an operating temperature of an enclosure of the mobile device and an operating temperature of electronic circuitry of the mobile device.

6. The mobile device of claim 5, wherein the control unit is configured to compare a temperature signal from at least one temperature sensor configured to sense the operating temperature of the enclosure of the mobile device to a lower temperature threshold, and in response to the temperature signal being equal to or greater than the lower temperature threshold, the control unit is configured to implement a thermal mitigation plan that suspends a first class of mobile device services.

7. The mobile device of claim 6, wherein the control unit is configured to compare a temperature signal from at least one temperature sensor configured to sense the operating temperature of the electronic circuitry of the mobile device to a higher temperature threshold, and in response to the temperature signal being equal to or greater than the higher temperature threshold, the control unit is configured to implement a thermal mitigation plan that suspends a second class of mobile device services.

8. The mobile device of claim 7, wherein in response to a comparison of the temperature signal from the at least one temperature sensor configured to sense the operating temperature of the enclosure of the mobile device indicating a temperature lower than a predetermined temperature below the lower temperature threshold, the control unit is configured to restore at least one of the suspended classes of service.

9. The mobile device of claim 1, wherein the control unit is configured to compare a temperature signal from at least one temperature sensor to one of a plurality of temperature thresholds defined progressively between the lower temperature threshold and the higher temperature threshold, and in response to the temperature signal being equal to or greater than one of the plurality of temperature thresholds the control unit is configured to implement a corresponding thermal mitigation plan that suspends a class of mobile device services.

10. The mobile device of claim 10, wherein the each class of suspended mobile device services is a subset of the class of mobile device services suspended by the thermal mitigation plan corresponding to the next higher temperature threshold.

11. The mobile device of claim 1,
wherein the control unit is configured to compare a temperature signal from at least one of the one or more temperature sensors to a first temperature threshold; and
wherein, in response to the temperature signal being equal to or greater than the first temperature threshold, the control unit is configured to implement a thermal mitigation plan that suspends a first class of mobile device services.

12. The mobile device of claim 11,
wherein the control unit is configured to compare a temperature signal from at least one of the one or more temperature sensors to a second temperature threshold that is higher than the first temperature threshold; and
wherein, in response to the temperature signal being equal to or greater than the higher temperature threshold, the control unit is configured to implement a thermal mitigation plan that suspends a second class of mobile device services.

13. The mobile device of claim 1,
wherein the plurality of temperature thresholds comprise a first temperature threshold and a second temperature threshold, the first temperature threshold being lower than the second temperature threshold;
wherein the plurality of thermal mitigation plans comprise a first thermal mitigation plan and a second mitigation plan; and
wherein the control unit is configured to implement the first thermal mitigation plan when a temperature corresponding to the temperature signal exceeds the first temperature threshold.

14. The mobile device of claim 13, wherein the control unit is configured to implement the second thermal mitigation plan when a temperature corresponding to the temperature signal exceeds the second temperature threshold.

15. The mobile device of claim 1,
wherein the plurality of thermal mitigation plans comprise a first thermal mitigation plan for which the control unit is configured to suspend a first class of mobile device services and a second mitigation plan for which the control unit is configured to suspend a second class of mobile device services.

16. The mobile device of claim 15, wherein the first class of mobile device services is a subset of the second class of suspended mobile device services.

17. A method of providing thermal mitigation for a mobile device, the method comprising:
receiving at least one temperature signal indicative of at least one operating temperature of the mobile device;
comparing the at least one temperature signal to a plurality of progressively higher temperature thresholds; and
selecting one of a plurality of thermal mitigation plans based on one of a plurality of mobile device operating modes and the comparison of the at least one temperature signal with the plurality of temperature thresholds.

18. The method of claim 17, further comprising:
determining a first operating mode when the mobile device is performing operations usually performed in close proximity to a user's face and no accessories enabling the mobile device to be operated at a distance from a user's face are connected to the mobile device; and
determining a second operating mode when an accessory enabling the mobile device to be operated at a distance from a user's face are connected to the mobile device.

19. The method of claim 17, further comprising:
determining a first operating mode when the mobile device is performing operations usually performed in close proximity to a user's face and no accessories enabling the mobile device to be operated at a distance from a user's face are connected to the mobile device; and
determining a second operating mode when the mobile device is performing operations enabling the mobile device to be operated at a distance from a user's face.

20. The method of claim 17, further comprising:
setting a first temperature threshold of the plurality of temperature thresholds to a temperature consistent with human safety; and
setting a second temperature threshold of the plurality of temperature thresholds to a temperature consistent with a safe operating temperature to prevent damage to the mobile device.

21. The method of claim 17, further comprising:
comparing a temperature signal indicative of a sensed operating temperature of an enclosure of the mobile device to a lower temperature threshold; and
in response to the temperature signal equal to or greater than the lower temperature threshold, implementing a thermal mitigation plan that suspends a first class of mobile device services.

22. The method of claim 21, further comprising:
comparing a temperature signal indicative of the sensed operating temperature of the electronic circuitry of the mobile device to a higher temperature threshold, and
in response to the comparison of the temperature signal indicating a temperature equal to or greater than the higher temperature threshold, implementing a thermal mitigation plan that suspends a second class of mobile device services.

23. The method of claim 22, wherein in response to a comparison of the temperature signal indicative of the operating temperature of the enclosure of the mobile device indicating a temperature lower than a predetermined temperature below the lower temperature threshold, restoring at least one of the suspended classes of service.

24. The method of claim 17, further comprising:
comparing temperature signal from at least one temperature sensor to one of a plurality of temperature thresholds defined progressively between the lower temperature threshold and the higher temperature threshold; and
in response to the temperature signal indicating a temperature equal to or greater than one of the plurality of temperature thresholds, implementing a corresponding thermal mitigation plan that suspends a class of mobile device services.

25. The method of claim 24, wherein the each class of suspended mobile device services is a subset of the class of mobile device services suspended by the thermal mitigation plan corresponding to the next higher temperature threshold.

26. The method of claim 17, further comprising implementing a first thermal mitigation plan when a temperature corresponding to the temperature signal exceeds a first temperature threshold.

27. The method of claim 26, further comprising implementing a second thermal mitigation plan when a temperature corresponding to the temperature signals exceeds a second temperature threshold higher than the first temperature threshold.

28. The method of claim 17, further comprising:
suspending a first class of mobile device services according to a first thermal mitigation plan; and
suspending a second class of mobile device services according to a second thermal mitigation plan.

29. The method of claim 28, wherein the first class of mobile device services is a subset of the second class of suspended mobile device services.
